(19) United States
(12) Patent Application Publication
(10) Pub. No.: US 2007/0155563 A1
(43) Pub. Date: Jul. 5, 2007

(54) Solid lubrication oil-free chain

(76) Inventor: Toshihiko Aoki, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/517,760

(22) Filed: Sep. 8, 2006

(30) Foreign Application Priority Data
Dec. 20, 2005 (JP) 2005-366869

(51) Int. Cl. F16G 13/02

(52) U.S. Cl. 474/206

(57) ABSTRACT

An oil-free chain that includes excellent lubricating properties, and satisfactorily maintains the lubricating properties even in high temperature atmosphere and dust particle atmosphere so that a stable lubrication effect can be maintained for a long period of time. The chain is a bush chain having a pair of inner plates into which the opposite ends of a bush are fitted, and a pair of outer plates which mount the opposite ends of a pair of pins. The pins are rotatably fit-inserted into the bushes of adjoining outer link plates. The inner and outer plates are connected in alternation to form the roller chain in which a roller is rotatably mounted on the outer surface of each bush. A sliding member formed of a 100% graphite sheet is provided between the bush and the pin and/or between the bush and the roller.

### FIELD OF INVENTION

The present invention relates to an oil-free chain used in a power transmission mechanism, a transfer mechanism and the like, and more specifically relates to an oil-free chain provided with a sliding member between a bush and a pin and/or between a bush and a roller.

### BACKGROUND OF THE INVENTION

As an oil-free chain used in a power transmission mechanism, a transfer mechanism and the like, there have been chains in which using an oil-containing sintered bush as a bush fitted to inner plates impregnating lubricating oil is supplied between a bush and a pin, and in which an O-ring is disposed between an inner plate and an outer plate to seal the gap between a bush and a pin whereby the leakage of lubricating oil such as encapsulated grease or the like is prevented and infusion of foreign materials from outside is also prevented.

Further, as a sliding material excellent in lubricating properties a metallic or resin slide bearing containing a solid lubricant such as graphite, molybdenum disulfide, polytetrafluoroethylene or the like is provided on an inner surface of a roller fitted on a bush so that wear between an outer circumferential surface of the bush and an inner circumferential surface of the roller is reduced (see Japanese Laid-Open Patent Publication No. Hei 11-351338).

### PROBLEMS TO BE SOLVED BY THE INVENTION

However, there are problems that in the oil-free chain using the above-mentioned impregnating sintered bush since impregnated lubricating oil is oozed out more than required due to an atmospheric temperature or frictional heat and an amount of retained oil is small, a stable lubrication effect cannot be maintained for a long period of time and that in the oil-free chain in which an O-ring is disposed between an inner plate and an outer plate, since filled lubricating oil is a little, the chain is liable to deteriorate due to friction heat and a stable lubrication effect cannot be also maintained for a long period of time. And there are problems that since these chains use lubricating oil, they cannot be used in such a high temperature atmosphere as at 450 to 600 degrees C. particularly and when this chain is used in an atmosphere of dust particles the lubricating oil is absorbed into the dust particles whereby the service life of an oil-free chain is more shortened.

Further, since a solid lubricant-containing sliding member has a small amount of a solid lubricant as in an oil-containing sintered bush, the service life of an oil-free chain is short, and particularly there is a problem that a resin sliding member cannot be used at high temperature so that a use temperature is restricted.

### SUMMARY OF THE INVENTION

Accordingly, the object of the present invention is to solve the above-mentioned prior art problems or to provide an oil-free chain that includes excellent lubricating properties, and satisfactorily maintains the lubricating properties even in high temperature atmosphere and dust particle atmosphere so that a stable lubrication effect can be maintained for a long period of time.

The invention solves the above-described problems by that, in a solid lubrication oil-free chain in which a pair of inner plates into which both ends of a bush are fitted and a pair of outer plates into which both ends of a pin rotatably fit-inserted into said bush are fitted are alternately connected in a large number, a sliding member formed of a 100% graphite sheet is provided between said bush and said pin. Here the “graphite” in the present invention means a natural graphite, an artificial graphite or the mixture thereof.

A feature of the invention solves the above-described problems by providing that said sliding member is pressurized onto an inner surface of said bush or an outer surface of said pin;

Another feature of the invention solves the above-described problems by providing a concavity, which locks said sliding member, on the inner surface of said bush or the outer surface of said pin.

Another feature of the invention solves the above-described problems by disposing an O-ring between said outer plate and said bush or said inner plate.

The invention solves the above-described problems in a chain in which a pair of inner plates into which both ends of a bush are fitted and a pair of outer plates into which both ends of a pin are fit, so that the pins may rotate in said bushes to interconnect the inner and outer links in alternation, and a roller is rotatable on an outer surface of said bush, a sliding member formed of a 100% graphite sheet is provided between said bush and said roller.

The solid lubrication oil-free chain according to another feature of the invention provides that the graphite sliding member has a density of 1.0 g/cm³ or more.

The solid lubrication oil-free chain according to another feature of the invention provides that the graphite sliding member is formed into a cylindrical shape by previously compressing a graphite sheet.

### EFFECTS OF THE INVENTION

Since in a solid lubrication oil-free chain, a sliding member is provided between a bush and a pin or between a bush and a roller, sliding wear between the bush and pin or between the bush and roller, which are brought into sliding contact with each other, can be prevented. Further the illustrated embodiments of the invention exhibit peculiar effects.

Namely, since a sliding member provided between the bush and pin or between the bush and roller is formed of a 100% graphite sheet excellent in lubricating properties, a lubricating action is sufficiently exhibited on the entire sliding surface and the lubrication properties are enhanced so that an oil-free operation for a long period of time can be attained. Further, even in such a high temperature atmosphere as 450 to 650 degrees C. the oil-free chain does not lose the lubricating properties and even in a dust particle atmosphere, it exhibits a lubrication effect without absorbing the dust particles. And since the sliding member is formed of a graphite sheet, the handling of the sliding sheet is easy and it can be easily provided between the bush and pin or between the bush and roller.

Further, when the sliding member is pressurized onto an inner surface of the bush or an outer surface of the pin, the oil-free chain is densified and is increased in lubrication performance, so that the service life of the oil-free chain can be more improved. Further, since the bush and the pin or roller in the solid lubrication oil-free chain can be produced in the same manner as in prior chains, the chain assembly operation for the present invention can be performed without increasing steps.

Further, when a concavity, which locks the sliding member, is formed on the inner surface of the bush or the outer surface of the pin, the pulling out of the sliding member can be prevented during the assembly of the chain so that the productivity of the chain can be enhanced.

Further, when an O-ring is disposed between the outer plate and the bush or inner plate or between the roller and the inner plate, the infusion of foreign materials from outside can be prevented, and even if the sliding member wears, the leakage of wear powder is prevented so that lubrication effects are maintained. Particularly, when an O-ring accommodating concavity such as a recess or the like is provided on an inner surface of an end portion of the bush or roller so that a part of the O-ring protrudes from an end surface of the bush or roller, excessive deformation of the O-ring due to compression of the O-ring between the bush and the outer plate or between the roller and the inner plate is prevented so that the service life of the chain can be improved. Further, when an end portion of the bush protrudes from the inner plate and an O-ring is disposed between the inner plate and the outer plate in such a manner that the O-ring surrounds the outer circumferential surface of this protruded portion, since a part of the O-ring is protruded, the same effect as in the O-ring accommodating concavity can be obtained.

It has been found that if the sliding member has a density of 1.0 g/cm³ or more, the lubrication performance is remarkably improved so that the service life of the oil-free chain can be more improved.

If the sliding member is formed into a cylindrical shape by previously compressing the graphite sheet, the density is enhanced and the lubrication effect is improved. Also, the sliding member can be easily attached to a bush or a roller whereby the assembly efficiency of the chain can be improved.

### BEST MODE FOR CARRYING OUT THE INVENTION

In a bush chain in which a number of a pair of inner plates in which both ends of a bush are respectively fitted and a number of a pair of outer plates in which both ends of a pin rotatably fit-inserted into said bush are respectively fitted are alternately connected to each other, and in a roller chain in which a roller is rotatably fit-inserted onto an outer surface of the bush, if the solid lubrication oil-free chain according to the present invention includes excellent lubricating properties and excellently maintains lubrication performance even in a high temperature atmosphere and a dust particle atmosphere a sliding member so that stable lubrication effects can be maintained for a long period of time by providing a sliding member formed of a 100% graphite sheet between the bush and pin or between the bush and roller, any concrete embodiments of the oil-free chain may be used.

Namely, the chain used in the present invention may be a bush chain or a roller chain and when a roller chain is used, a sliding member or sliding members may be attached between a roller and a bush and/or between a bush and a pin.

If the sliding member is formed of a graphite sheet of 100% graphite that is a 100% natural graphite, 100% artificial graphite or a 100% mixture thereof and can be provided between a pin and a bush or between a bush and a roller, any shape of the sliding member may be used. However, the sliding member is preferably formed into a cylindrical shape by previously compressing a graphite sheet or by pressurizing a graphite sheet onto inner surfaces of the bush and roller or outer surfaces of the pin and bush. Thus in a case where the sliding member is formed by pressurization, it is preferable to provide a concavity into which the graphite sheet is displaced to be locked, or which exhibits an anchoring effect, on the inner surfaces of the bush and roller or the outer surfaces of the pin and bush, which function as formation surfaces of the sliding member.

Examples of the present invention will be described with reference to drawings.

### BRIEF DESCRIPTION OF THE DRAWINGS

FIG. 1 is a perspective view of a solid lubrication oil-free chain embodying the present invention, showing parts thereof in an assembly view;

FIG. 2 is an enlarged cross-sectional view taken on the line A-A of FIG. 1;

FIG. 2(a) is an enlargement of the area encircled in FIG. 2;

FIG. 3 is an explanatory view of the steps in manufacturing a sliding member in one embodiment of the present invention.

FIGS. 4 and 4(a) are views similar to FIGS. 2 and 2(a) showing a second embodiment of the present invention.

FIG. 5 is an explanatory view of manufacturing a sliding member in an embodiment of the present invention;

FIGS. 6(a), 6(b) and 6(c) are perspective views, with portions broken away, of different bushes made in accordance with the present invention; and

FIG. 7 is a wear gradient graph showing the relationship between the density of a graphite sheet and the wear loss.

### DESCRIPTION OF THE PREFERRED EMBODIMENTS

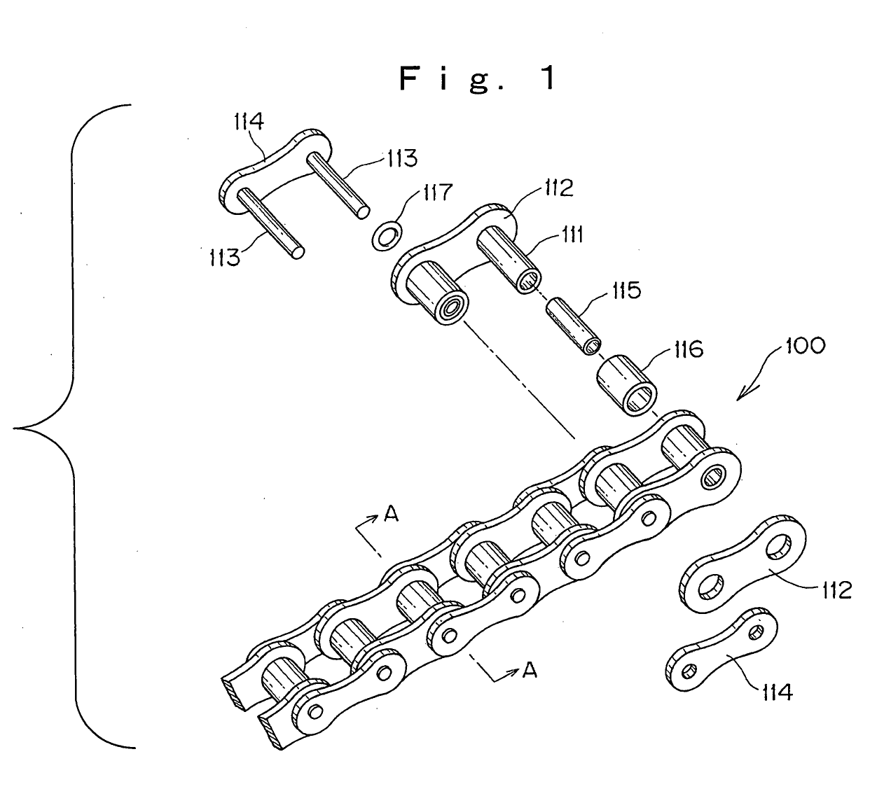

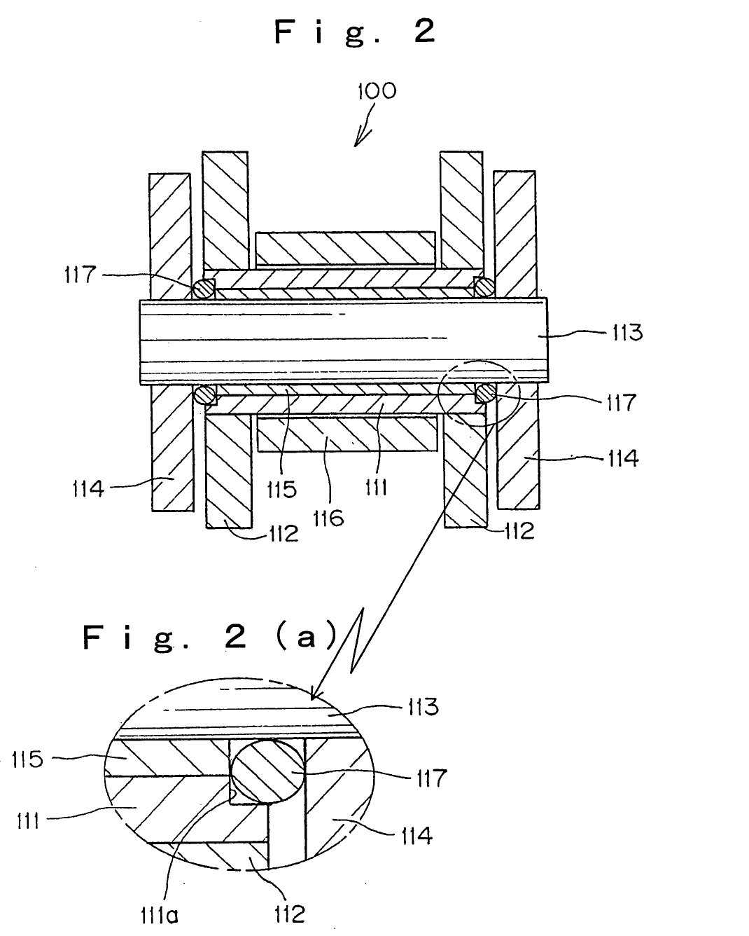

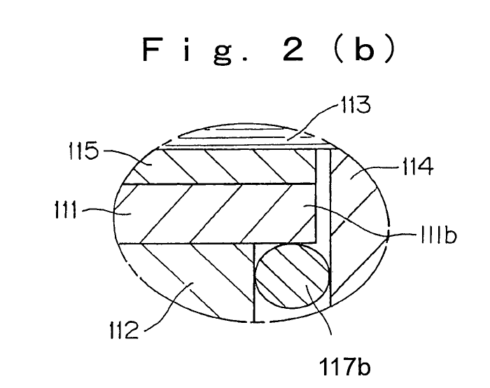

In a solid lubrication oil-free chain 100 according to Example 1, as shown in FIGS. 1 and 2, a pair of inner plates 112, 112 are disposed in spaced parallel relation. Bushes 111 with interior and exterior cylindrical surfaces have their opposite ends fitted into the inner plates 112, In addition, a large number of pairs of outer plates 114,114 alternately connect with a like number of pairs of the inner plates, each pair of outer plates having a pair of pin members 113 connecting the plates and rotatable in the interior surfaces of the bushes 111 which are mounted in the two adjoining inner plates.

A roller member 116 is rotatable on the exterior cylindrical surfaces of each of the bushes 111, whereby the bushes 111 may rotate on the exterior of the pin member 113 and in the interior of the roller members 116. An O-ring 117 surrounds the pin 113.

This O-ring 117 is attached to a recess 111a formed on an inner surface of an end portion of the bush 111 as shown in an enlarged view of FIG. 2a in such a manner that a part of the O-ring 117 is protruded from an end surface of the bush 111. And the compression ratio of the O-ring is set to 20 to 30% or less so that a damage of the O-ring due to an excessive deformation is prevented.

It is noted that as shown in an enlarged view of FIG. 2b, an end portion of the bush 111 protrudes from the inner plate 112 so that the O-ring 117b may be disposed between the inner plate 112 and the outer plate 114 in such a manner that the O-ring surrounds an outer circumferential surface of the protruded portion 111b. In this case, a part of the O-ring 117b is protruded from an end surface of the bush 111 and a damage of the O-ring can be prevented as in the case where the O-ring 117 is attached to the recess 111a.

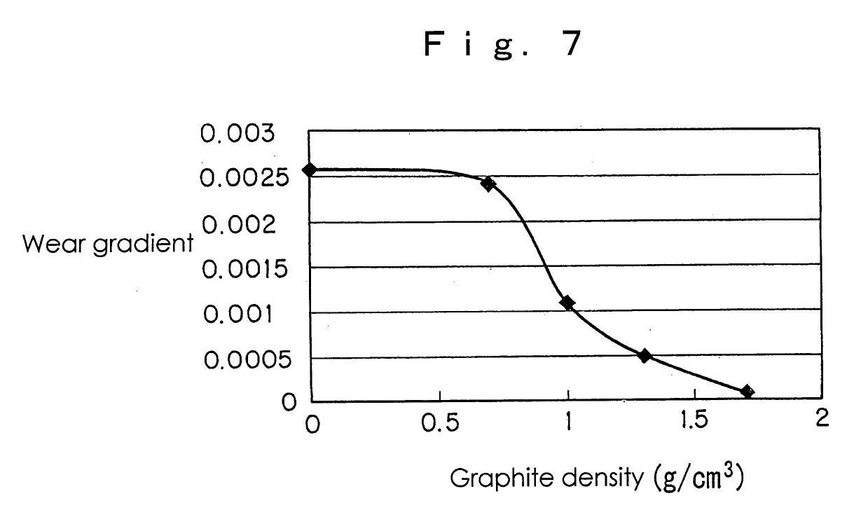

The relationship between the density of the graphite sheet and the wear elongation of the chain, is shown in FIG. 7 as a wear gradient graph, a wear loss is rapidly lowered from a graphite sheet density of about 0.7 g/cm³ and the wear gradient becomes gentle from 1.0 g/cm³. Thus the density of the graphite sheet is preferably 1.0 g/cm³ or more.

FIG. 7 has the abscissa as the density (g/cm³) of the graphite sheet and the ordinate as the wear gradient. The wear gradient is represented by wear elongation per unit slide number (mm/n, n means a slide number).

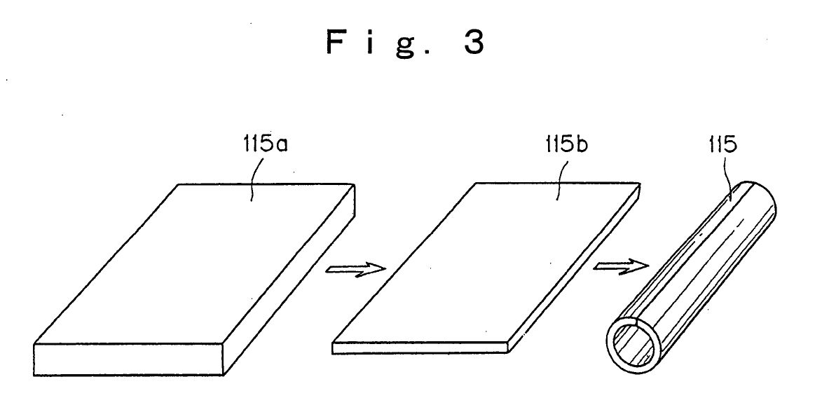

As shown in FIG. 3, a sliding member 115 is formed by compressing a low density 100% graphite sheet 115a to a high density graphite sheet 115b, and molding in a cylindrical shape. The density of the compressed graphite sheet is 1.0 g/cm³ and more.

The sliding member 115 is attached to the inner surface of the bush 111 or the outer surface of the pin 113 before the assembly of chain or during assembly thereof. When a chain is assembled, it produces a solid lubrication oil-free chain 100 of the present invention in which the sliding member 115 is provided between the bush 111 and the pin 113,

In this manner since in the sliding member 115 in Example 1 a 100% graphite sheet excellent in a self lubricating property is used and is compressed to enhance the lubrication performance and the entire sliding surface of the bush or pin comes into contact with the graphite, the sliding wear is remarkably reduced so that a long service life of the chain can be attained. The O-ring disposed between the bush 111 and the outer plate 114 blocks the infusion of different materials between the bush 111 and pin 113 from outside so that the damage of the sliding member by different material can be prevented. And even if the sliding member wears since the scattering of wear powders having lubrication performance is prevented and the wear powders can be held between the bush 111 and pin 113 and near them, the lubrication effects can be maintained.

It is noted that although Example 1 uses a roller chain, it can also be adapted to a bush chain having no roller. Further, the O-ring is not necessarily required. However, since, particularly in use of the chain at an ordinary temperature or in an intermediate temperature atmosphere where the O-ring does not deteriorate the lubrication effects can be maintained as described above, the O-ring is preferably used.

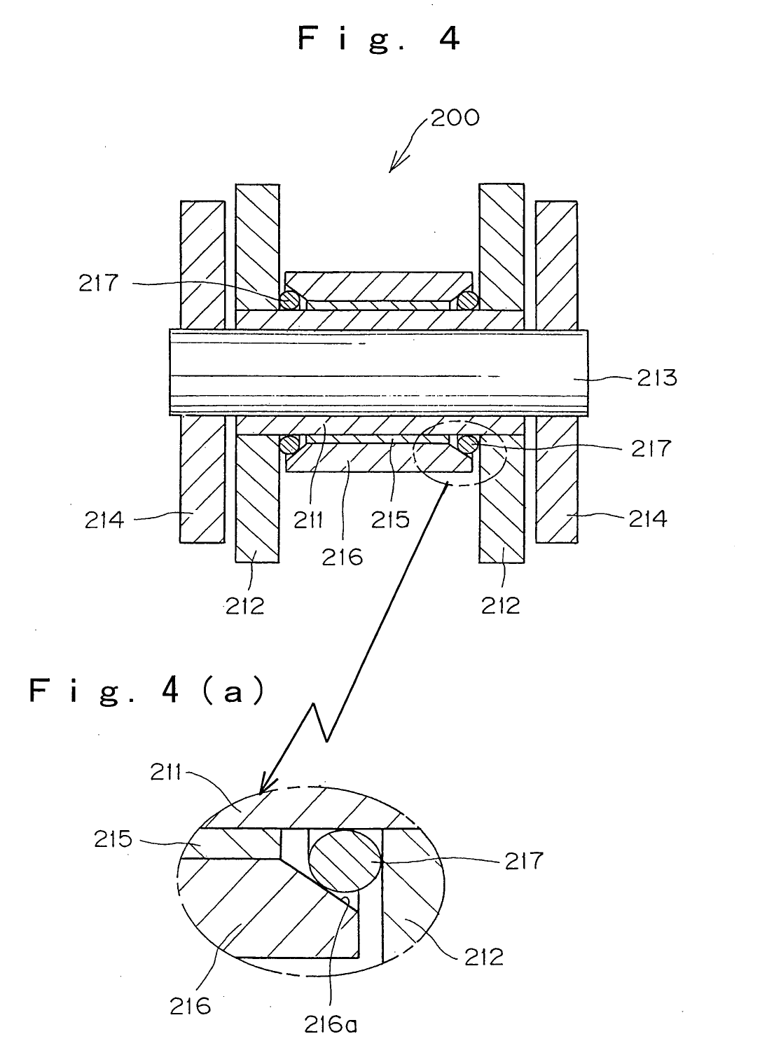

Next, Example 2 of the present invention will be described with reference to FIG. 4.

Since Example 2 of the present invention is differentiated from the solid lubrication oil-free chain 100 of Example 1 only in that a sliding member is attached between a roller and a bush and an O-ring is attached between the roller and an inner plate, and other concrete configurations in Example 2 are the same as in Example 1, the elements are identifies with the same members in Example 2 as in the solid lubrication oil-free chain 100 in Example 1, except that they are denoted by reference numerals of a 200 series. The parts of this embodiment which correspond to parts in the first embodiment have a reference numeral consisting of same numeral of the first embodiment plus 100. Overlapping descriptions of the members are omitted.

In a solid lubrication oil-free chain 200 according to Example 2, as shown in FIGS. 4 and 4(a), a pair of inner plates 212, 212 are disposed in spaced parallel relation. Bushes 211 with interior and exterior cylindrical surfaces have their opposite ends fitted into the inner plates 212, In addition, a large number of pairs of outer plates 214,214 alternately connect with a like number of pairs of the inner plates. Each pair of outer plates 214 has a pair of pin members 213 connecting the plates and rotatable in the interior surfaces of the bushes 211 which are mounted in the two adjoining inner plates 212. A roller 216 is rotatable on an outer surface of the bush 211, and between the bush 211 and the pin 213 a sliding member 215 is provided.

Further, between the roller 216 and the inner plate 212 is disposed an O-ring 217 in such a manner that the O-ring surrounds the bush 211.

This O-ring 217 is attached to a conical concavity 216a formed on an inner surface of an end portion of the roller 216 as shown in an enlarged view of FIG. 4 in such a manner that a part of the O-ring 217 is protruded from an end surface of the roller 216. And the compression ratio of the O-ring is set to 20 to 30% or less so that damage to the O-ring due to an excessive deformation is prevented.

It is noted that although in Example 2 the O-ring 217 is attached to the conical concavity 216a, after a recess is formed on an inner surface of an end portion of a roller and the conical concavity 216a may be mounted in this recess as in the O-ring 117 in Example 1. Alternatively, in the case of the O-ring 117 in Example 1, after forming a recess on an inner surface of an end portion of the bush 111, the O-ring may be mounted in the concavity.

The sliding member 215 in Example 2 is formed by compressing a 100% graphite sheet 115a in a cylindrical shape as in Example 1. The sliding member 215 is attached to an inner surface of the roller 216 or an outer surface of the bush 211 before the assembly of chain or during assembly thereof to assemble a chain whereby a solid lubrication oil-free chain 200 of the present invention in which the sliding member 215 is provided between the bush 211 and the roller 216 can be obtained.

Thus, since in the sliding member 215 in Example 2 the sliding wear between the bush 211 and the roller 216 can be remarkably reduced as in Example 1, the service life of the chain can be elongated. Further, the O-ring 217 disposed between the inner plate 212 and the roller 216 blocks the infusion of different materials between the bush 211 and roller 216 from outside as in Example 1 so that the lubrication effects can be maintained.

It is noted that although in Example 2 the sliding member 215 is provided between the roller 216 and the bush 211, it may be provided between the bush 211 and a pin 213. Further, the O-ring is not necessarily required. However, since, particularly in use of the chain at an ordinary temperature or in an intermediate temperature atmosphere where the O-ring does not deteriorate, and the lubrication effects can be maintained as described above, the O-ring is preferable.

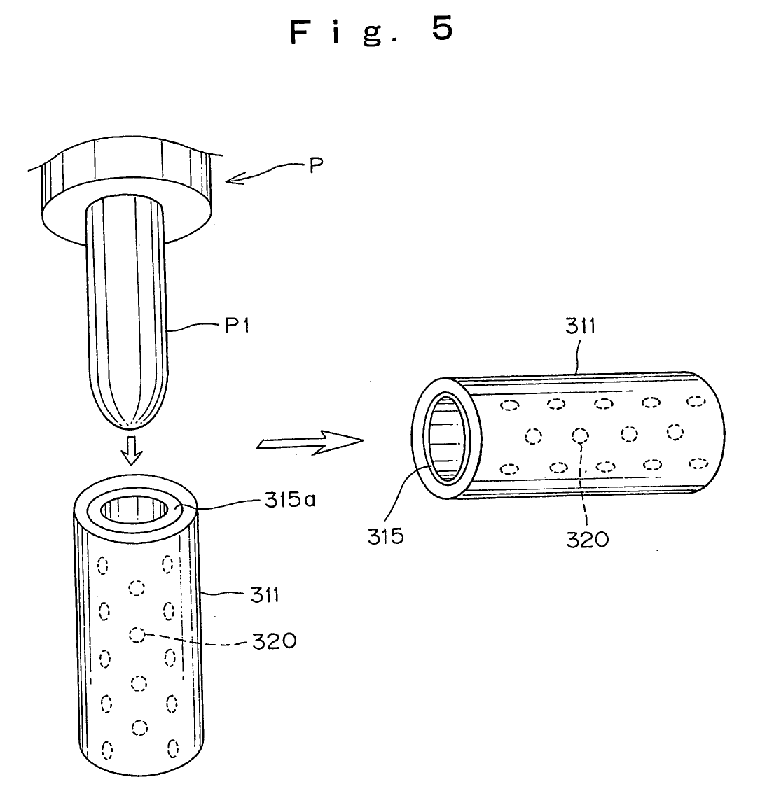

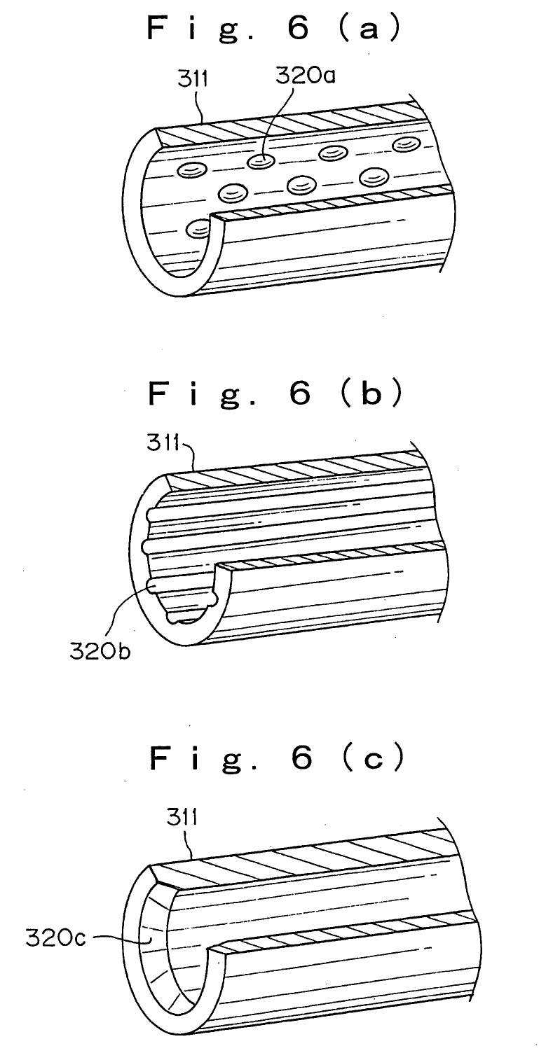

The above-mentioned Examples 1 and 2 use sliding members 115 and 215 each obtained by previously compressing a graphite sheet in a cylindrical shape. However, Example 3 in which a graphite sheet is pressurized onto an inner surface of a bush, that is a sliding member is pressurized onto the inner surface of the bush will be described with reference to FIGS. 5 and 6.

It is noted that since Example 3 is the same as the solid lubrication oil-free chain 100 of the above-mentioned Example 1 except that the sliding member is pressurized onto the inner surface of the bush, a bush 311 on whose inner surface the sliding member is pressurized will be described.

The sliding member 315 of Example 3 is obtained by pressurizing a 100% graphite sheet onto an inner surface of a bush 311, as shown in FIG. 5. In this case a cylindrical body 315a composed of a low density graphite sheet is disposed in the bush 311. After that, a punch P1 of a press machine P is press-fitted into the cylindrical body 315a. Then the punch P1 has such a clearance that this cylindrical body 315a has a required compression thickness. After the press-fitting, the cylindrical body 315a is compressed in the radial direction of the bush 311 so that a sliding member 315 is formed on the inner surface of the bush 311.

In this case concavities 320 are preferably provided on the inner surface of the bush 311 so that a part of pressurized graphite sheet is imbedded into the cavities and the body 315 is locked to the bush with an anchoring effect.

This concavities 320 may have any shape if a part of the pressurized sliding member 315 is locked so that anchoring effect of the sliding member 315 can be exhibited. Various shapes of the concavities include a hemispherical concavity 320a having a circular opening as shown in FIG. 6a; an axially extending grooved concavity 320b are shown in FIG. 6b; concavities may be formed on the inner surface and the end surface of the bush 311 as shown at 320c in FIG. 6c; and other configurations may be used. In place of the circular concavity 320a in FIG. 6a, a polygonal or oval concavity may be used. Further, instead of the open-ended grooved concavities 320b in FIG. 6b, blind grooves whose both ends are closed may be used, or even circumferential groves may be used. Alternatively, in place of the conical concavity 320c in the end of the bush 311 in FIG. 6c, a cylindrical recess may be used.

It is noted that although in Example 2 a solid lubrication oil-free chain in which the sliding member 315 is pressurized onto the inner surface of the bush 311 has been described, the sliding member 115, 215 or 315 may be formed on the outer surface of a pin 113, 213 or 313 (not shown). Further, in the case where a sliding member 115, 215 or 315 is provided between the roller 112, 212 or 312 (not shown), and the bush 111, 211 or 311, the sliding member may be formed on the inner surface of the roller and on the outer surface of the bush.

As described above, since, in the solid lubrication oil-free chain according to the present invention, the sliding member provided between the bush and the pin or between the bush and the roller is formed of a 100% graphite sheet having excellent lubricating properties, the sliding wear between the bush and the pin or between the bush and the roller is remarkably suppressed and a stable lubrication effect is maintained for a long period of time. Particularly, the solid lubrication oil-free chain according to the present invention can excellently maintain the lubricating properties even in a high temperature atmosphere such as at 450 to 600 degrees C. or in a dust particle atmosphere. Thus the effects of the present invention are very great.

1. A solid lubrication oil-free chain comprising a pair of inner plates in spaced parallel relation, bushes positioned between said inner plates. said bushes comprising interior and exterior cylindrical surfaces, and having opposite ends fitted into said inner plates, pairs of outer plates alternately connected with said pairs of inner plates in a large number, each pair of outer plates adjoining a pair of said inner plates at each end of said pair of outer plates, each said outer plates having a pair of pin members rotatable in the interior surfaces of the bushes in said two adjoining inner plates, and a roller member rotatable on the exterior cylindrical surfaces of each of said bushes whereby said bushes may rotate on the exterior of said pins and in the interior of said rollers, said chain including
a sliding member formed of a 100% graphite sheet positioned between said bush and at least one selected member of said pin member and said roller member.

2. A solid lubrication oil-free chain according to claim 1, wherein said sliding member is pressurized onto a selected one of said interior surface of said bush and said outer surface of said pin member.

3. A solid lubrication oil-free chain according to claim 2, including a concavity formed on said selected one surface to lock said sliding member to said selected one surface.

4. A solid lubrication oil-free chain according to claim 1, including an O-ring disposed between said at least one selected member and an adjacent plate at each end of said sliding member.

5. A solid lubrication oil-free chain according to claim 1, wherein said sliding member is provided between said bush and said pin member.

6. A solid lubrication oil-free chain according to claim 1, wherein said sliding member is provided between said bush and said roller member.

7. A solid lubrication oil-free chain according to claim 6, characterized in that said sliding member is pressurized onto a selected one surface of the outer surface of said bush and the inner surface of said roller.

8. A solid lubrication oil-free chain according to claim 7, characterized in that a concavity is on said selected one surface to lock said sliding member to said selected one surface.

9. A solid lubrication oil-free chain according to claim 1, including O-rings disposed between said bushing and said outer plate at the opposite ends of said sliding member.

10. A solid lubrication oil-free chain according to claim 9, including recessed cavities in the ends of said bushing to house said O-rings.

11. A solid lubrication oil-free chain according to claim 1, including O-rings disposed between said roller member and said inner plate at the opposite ends of said sliding member.

12. A solid lubrication oil-free chain according to claim 11, including recessed cavities in the ends of said roller member to house said O-rings.

13. A solid lubrication oil-free chain according to claim 1, including O-rings disposed between said outer plate and said inner plate at the opposite ends of said bushing.

14. A solid lubrication oil-free chain according to claim 1, wherein said sliding member has a density of at least 1.0 g/cm³.

15. A solid lubrication oil-free chain according to claim 1, wherein said sliding member has a hollow cylindrical shape and consists of a compressed graphite sheet.

16. A solid lubrication oil-free chain comprising a pair of inner plates in spaced parallel relation, bushes positioned between said inner plates. said bushes comprising interior and exterior cylindrical surfaces, and having opposite ends fitted into said inner plates, pairs of outer plates alternately connected with said pairs of inner plates in a large number, each pair of outer plates adjoining a pair of said inner plates at each end of said pair of outer plates, each said outer plates having a pair of pin members rotatable in the interior surfaces of the bushes in said two adjoining inner plates, and a roller member rotatable on the exterior cylindrical surfaces of each of said bushes whereby said bushes may rotate on the interior of said rollers, said chain including
a sliding member formed of a 100% graphite sheet positioned between said bush and said roller member.

17. A solid lubrication oil-free chain comprising a pair of inner plates in spaced parallel relation, bushes positioned between said inner plates. said bushes comprising interior and exterior cylindrical surfaces, and having opposite ends fitted into said inner plates, pairs of outer plates alternately connected with said pairs of inner plates in a large number, each pair of outer plates adjoining a pair of said inner plates at each end of said pair of outer plates, each said outer plates having a pair of pin members rotatable in the interior surfaces of the bushes in said two adjoining inner plates, whereby said bushes may rotate on the exterior of said pins, said chain including
a sliding member formed of a 100% graphite sheet positioned between said bush and said pin member.
